(19) United States
(12) Patent Application Publication
(10) Pub. No.: US 2008/0256919 A1
(43) Pub. Date: Oct. 23, 2008

(54) QUICK RELEASE LAWN MOWER HANDLEBAR HEIGHT ADJUSTMENT

(76) Inventor: Fredric D. Schreiner, Green Bay, WI (US)

Correspondence Address: MICHAEL BEST & FRIEDRICH LLP, 100 E WISCONSIN AVENUE, Suite 3300, MILWAUKEE, WI, 53202, US

(21) Appl. No.: 11/736,619

(22) Filed: Apr. 18, 2007

(51) Int. Cl. A01D 34/28

(52) U.S. Cl. 56/17.2

(57) ABSTRACT

A lawn mower includes a cutting deck, a cutting blade positioned underneath the cutting deck, a prime mover driving rotation of the blade, a plurality of wheels supporting the cutting deck, a handle extending upward from the deck, and a clamp mechanism. The clamp mechanism is actuable without the use of tools to clamp the handle against a portion of the deck to fix by friction alone the handle against pivoting with respect to the deck. The mechanism may also be unclamped to permit the handle to pivot with respect to the deck. The clamp mechanism may in some embodiments include first and second clamp mechanism that clamp first and second portions of the handle to respective first and second portions of the deck.

### BACKGROUND

The present invention relates to a quick release clamp for permitting the quick adjustment of the height of a handlebar on a lawn mower.

### SUMMARY

In one embodiment, the invention provides a lawn mower comprising: a cutting deck; a cutting blade positioned underneath the cutting deck; a prime mover driving rotation of the blade; a plurality of wheels supporting the cutting deck; a handle extending upward from the deck; and a clamp mechanism actuable without the use of tools to clamp the handle against a portion of the deck to fix by friction alone the handle against pivoting with respect to the deck, and to unclamp the handle from the deck to permit the handle to pivot with respect to the deck.

In another embodiment, the invention provides a lawn mower comprising: a cutting deck having first and second mounting portions; a cutting blade positioned underneath the cutting deck; a prime mover to rotate the blade; a plurality of wheels supporting the cutting deck; a handle having first and second legs and being pivotable with respect to the deck to position the handle at a desired height for an operator; and a first and second mechanisms that clamp the respective first and second legs to the respective first and second mounting portions of the deck to fix with friction alone the handle against pivoting with respect to the deck when the mechanisms are in clamped positions, and that permit pivoting of the handle with respect to the deck when the mechanisms are in unclamped positions.

In another embodiment, the invention provides a method of adjusting the height of a handle of a lawn mower that includes a deck, a cutting blade positioned below the deck, and an internal combustion engine driving rotation of the cutting blade, the method comprising: pivotably coupling a lower end of the handle to the lawn mower deck; pivoting the handle with respect to the deck to position the handle at a desired height; and clamping a portion of the handle to a portion of the deck to fix by friction alone the handle against pivotal movement with respect to the deck.

Other aspects of the invention will become apparent by consideration of the detailed description and accompanying drawings.

### BRIEF DESCRIPTION OF THE DRAWINGS

FIG. 1 is a perspective view of a lawn mower and clamp mechanism according to one embodiment of the invention.

FIG. 1A is an enlarged side view of the lawn mower and clamp mechanism of FIG. 1.

FIG. 2 is a cross-sectional view taken along line 2-2 in FIG. 1A, and illustrating the clamp mechanism in an unlocked condition.

FIG. 3 is a cross-sectional view taken along line 2-2 in FIG. 1A, and illustrating the clamp mechanism in a locked condition.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

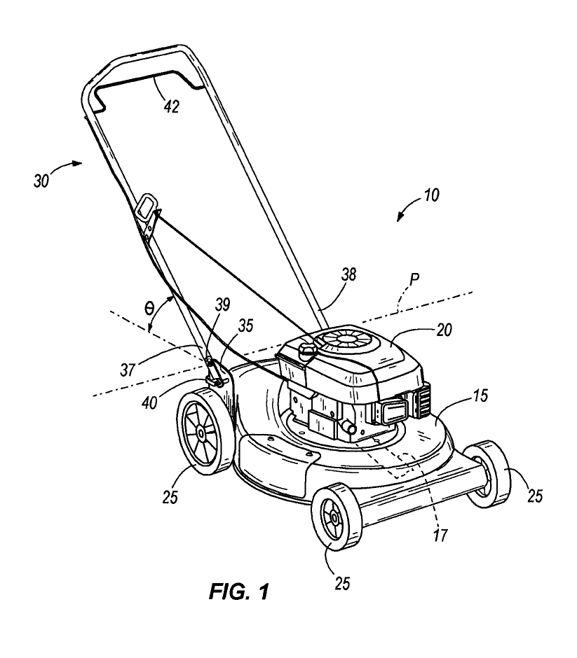

FIG. 1 shows a walk behind lawn mower 10 having a cutting deck 15 and a rotatable blade 17 positioned below the cutting deck 15. A prime mover, such as an internal combustion engine 20 drives the blade 17. The lawn mower 10 is movably supported by a plurality of wheels 25, any or all of which may in some embodiments be driven by the engine 20 or roll passively under the influence of an operator pushing the lawn mower 10. The lawn mower 10 further includes a handle 30 extending upwards at an angle Θ from rear deck portions or mounting portions 35. A first rear deck portion 35 is positioned above a first rear wheel 25 and a second rear deck portion 35 is positioned above a second rear wheel 25 on the other side of the lawn mower 10. The second rear deck portion 35 is obstructed from view in FIG. 1 by the engine 20, but is a substantial mirror image of the first rear deck portion 35.

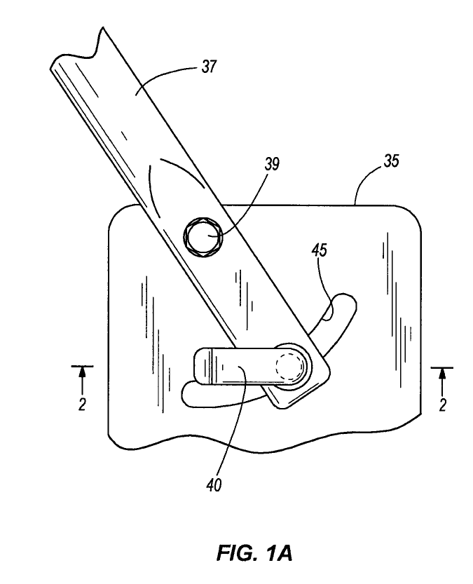

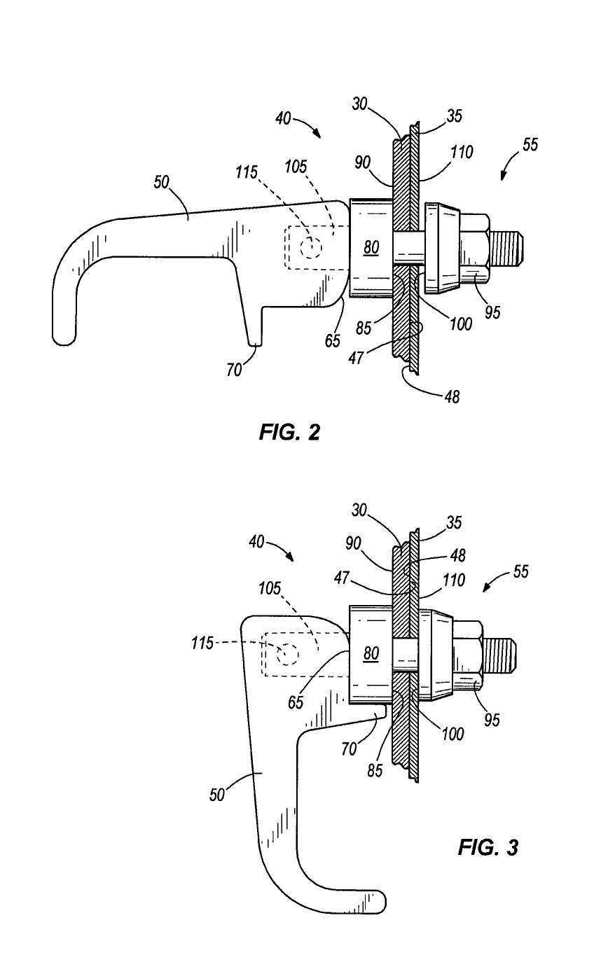

The handle 30 includes first and second legs 37, 38 that include ends positioned adjacent to the respective first and second rear deck portions 35. Each leg 37, 38 of the handle 30 is rotatably or pivotably coupled to the associated rear deck portion 35 with a pivot bolt 39 that defines a pivot axis for the leg 37 or 38. The handle is releasably secured against pivoting about the pivot bolt 39 by way of an adjustable clamp mechanism 40 that will be described in greater detail with reference to FIGS. 2 and 3. The pivot axes defined by the pivot bolts 39 are preferably collinear to define a single pivot axis P for the overall handle 30. A dead man handle 42 is provided on the upper portion of the handle 30. The dead man handle 42 is electrically connected to the engine 20 such that if the handle 42 is released it opens the engine ignition circuit to kill the engine 20.

As seen in FIG. 1A, a portion of each adjustable mechanism 40 is in an arcuate slot 45 in the rear deck portion 35. As will be described in more detail below, each adjustable mechanism 40 can be actuated to clamp the associated handle leg 37 or 38 to the associated rear deck portion 35, or can be actuated to release the leg for movement with respect to the associated rear deck portion 35. When both adjustable mechanisms 40 are released, the handle 30 is free to pivot about the pivot axis P defined by the pivot bolts 39. While the handle 30 is pivoted about the pivot bolts 39, the height and angle Θ of the handle 30 are adjusted and the adjustable mechanisms 40 move along their associated arcuate slots 45. In other embodiments, it is possible that the adjustable mechanisms 40 may act as the pivot points of the legs 37, 38, thereby removing the need for the arcuate slots 45 and pivot bolts 39.

FIGS. 2 and 3 show one of the adjustable mechanisms 40. The following description of the adjustable mechanism 40 applies with equal force to the other adjustable mechanism 40, which may be a substantial mirror image of the one illustrated. The illustrated mechanism 40 shown is similar in function to Southco Part No. 19-14-10. A generally planar portion 47 of the handle 30 is positioned adjacent and generally parallel to a generally planar portion 48 of the rear deck portion 35.

The mechanism 40 includes a lever 50 and a body 55. The illustrated lever 50 has a cam surface 65 and an abutment portion 70. The abutment portion 70 serves as a stop to limit movement of the lever 50. In another embodiment, the lever 50 does not have an abutment portion 70. The cam surface 65 is in contact with a washer 80. The washer 80 has a surface 85 adjacent to a generally planar portion 90 of the lawn mower handle 30.

The body 55 includes a nut 95 having a surface 100, and a shaft 105. The surface 100 is adjacent to a generally planar portion 110 of the deck 15. The nut 95 is threaded onto the shaft 105 and moves with the shaft 105. The shaft 105 extends through the slot 45, handle 30, and washer 80, and is pivotably coupled to the lever 50 by a dowel 115. The shaft 105 is movable with respect to the washer 80. In the unlocked or unclamped position (shown in FIG. 2), the distance between the nut 95 and washer 80 is maximized and the distance between the dowel 115 and the washer 80 is minimized—thereby relieving clamping pressure. When clamp pressure is relieved, the handlebar 30 can pivot to the desired angle Θ and height.

In other embodiments of the invention, the relative positions of the handle 30 and rear deck portion 35 can be reversed (or the mechanism 40 reversed) such that the handle 30 is on the nut 95 side and the rear deck portion 35 is on the lever 50 side. Also, in different embodiments the surfaces 85, 100 of the washer 80 and nut 95 may be smooth or serrated to facilitate a frictional engagement with the surfaces 90, 110.

Turning to FIG. 3, when the lever 50 is pivoted to the locked or clamped position, the cam surface 65 bears against the washer 80, and the geometry of the cam surface 65 draws the dowel 115 to move to the left as viewed in FIG. 3. As the dowel 115 moves to the left so do the shaft 105 and nut 95. Friction between the surfaces 85, 100 and the respective generally planar portions 90, 110, and friction between the generally planar portions 47, 48, inhibits relative pivotal movement of the handlebar 30 and the rear frame portion 35. In other words, the handle legs 37, 38 are clamped to the rear deck portions 35 when the lever 50 is pivoted to the locked or clamped position. In the locked position, the distance between the nut 95 and washer 80 is minimized and the distance between the dowel 115 and the washer 80 is maximized. Although the nut 95 and washer 80 are used in the illustrated embodiment, the mechanism 40 may include any other suitable first and second members to squeeze the legs 37, 38 against the respective deck portions 35.

In the illustrated embodiment, the handle 30 is not locked by a ratchet, finger, or detent system that only allow locking at specific intervals or angular positions. Rather, the handle 30 and adjustable mechanism 40 can be infinitely adjusted within a range of angles Θ and heights, because the handle 30 and deck portion 35 are inhibited from pivoting with respect to each other by frictional clamping forces (i.e., between the planar surfaces 47, 48, and between the surfaces 85, 100 and the respective planar surfaces 90, 110) alone. The frictional interface can be enhanced or improved by incorporating a friction-increasing surface on the generally planar portions 47, 48. Such friction-increasing surfaces may include for example, a roughened surface or a rubber or other high-friction material applied to one or both of the generally planar portions 47, 48.

In operation, to move the handle 30 to a different position, the lever 50 is pivoted to the unlocked position, as shown in FIG. 2, which releases the clamping force on the handle 30 and the rear frame member 35. The handle 30 is then pivoted about the pivot axis P defined by the pivot bolts 39 to any desired position or angle Θ within the range of possible positions or angles as the shaft 105 moves within the slot 45. To lock the lawn mower handle 30 in the desired position or angle Θ, the adjustable mechanism 40 is moved from the unlocked position to the locked position. In the locked position, the handle 30 and the rear frame member 35 are clamped together on one or both the left and the right sides of the lawn mower 10. No tools are needed for an operator to adjust the height or angle Θ of the handle 30 because the lever 50 is actuated by hand.

In the illustrated embodiment, one mechanism 40 is provided on each side of the handle 30 to clamp the ends of the legs 37, 38 of the handle 30 against respective rear frame portions 35 on the lawn mower 10. The first mechanism 40 clamps the surfaces 85, 100 against the respective generally planar surfaces 90, 110, and clamps generally planar portions 47 and 48 together, on a first side of the lawn mower 10. The second mechanism 40 clamps the surfaces 85, 100 against the respective generally planar surfaces 90, 110 and clamps generally planar portions 47 and 48 together, on a second side of the lawn mower 10.

In other embodiments, one mechanism 40 may clamp one of the legs 37, 38 of the handle 30 to a rear frame portion 35 on only one side of the lawn mower 10. In yet another embodiment, it is envisioned that one mechanism 40 will simultaneously clamp first and second side members or the left and right sides of the handle 30 to the left and right rear frame portions 35. For example, a single shaft 105 may extend between the rear frame portions 35 and slide axially in response to actuation of a single lever 50 to simultaneously tighten the left and right sides of the handle 30 to the respective rear portions 35.

Various features and advantages of the invention are set forth in the following claims.

What is claimed is:

1. A lawn mower comprising:
a cutting deck having an arcuate slot and a first smooth planar surface surrounding the arcuate slot;
a cutting blade positioned underneath the cutting deck;
a prime mover driving rotation of the blade;
a plurality of wheels supporting the cutting deck;
a handle extending upward from the deck, the handle being mounted to the cutting deck for pivotal movement within a range of motion about a pivot axis that is spaced a fixed distance from the arcuate slot, the handle including a second smooth planar surface; and
a clamp mechanism movable along the arcuate slot and first smooth planar surface in response to pivotal movement of the handle with respect to the deck, the clamp mechanism being actuable without the use of tools to clamp the first smooth planar surface against the second smooth planar surface to fix by friction alone the handle against pivoting with respect to the deck, and to unclamp the first and second smooth planar surfaces to permit the handle to pivot with respect to the deck, such that the handle may be infinitely adjusted and clamped at any angle within the range of motion.

2. (canceled)

3. (canceled)

4. The lawn mower of claim 1, wherein the clamp mechanism includes first and second spaced-apart members, wherein the handle and a portion of the deck are positioned between the first and second members with the first and second planar surfaces facing each other, and wherein actuation of the clamp mechanism into a locked position reduces the space between the first and second members to raise friction between the first and second smooth planar surfaces.

5. The lawn mower of claim 1, wherein the handle includes first and second legs; wherein the second smooth planar surface includes a leg smooth planar surface on each of the first and second legs; wherein the first smooth planar surface includes two deck smooth planar surfaces, each facing one of the leg smooth planar surfaces; and wherein the clamp mechanism includes first and second clamp mechanisms actuable without the use of tools to clamp the leg smooth planar surfaces against the deck smooth planar surfaces.

6. The lawn mower of claim 1, wherein the clamp mechanism includes a shaft having an axis and first and second members; wherein actuation of the clamp mechanism to a locked position causes axial movement of the shaft to decrease the distance between the first and second members and squeeze the smooth planar surfaces of the handle and the deck together.

7. (canceled)

8. The lawn mower of claim 1, wherein the clamp mechanism is carried by the handle and includes a portion extending through the arcuate slot; and wherein the portion extending through the arcuate slot moves along the arcuate slot as the handle is pivoted about the pivot axis with respect to the cutting deck.

9. A lawn mower comprising:
a cutting deck having first and second arcuate slots surrounded by respective first and second deck smooth planar surfaces;
a cutting blade positioned underneath the cutting deck;
a prime mover to rotate the blade;
a plurality of wheels supporting the cutting deck;
a handle having first and second legs that are pivotable with respect to the deck within a range of motion about respective first and second pivot axes that are spaced a fixed distance from the respective first and second arcuate slots to position the handle at a desired height for an operator, the first and second legs including respective first and second leg smooth planar surfaces; and
first and second mechanisms actuable to clamp the first and second leg smooth planar surfaces to the respective first and second deck smooth planar surfaces to fix with friction alone the handle against pivoting with respect to the deck when the mechanisms are in clamped positions, and that permit pivoting of the handle with respect to the deck when the mechanisms are in unclamped positions, such that the handle may be infinitely adjusted and clamped at any angle within the range of motion.

10. (canceled)

11. The lawn mower of claim 9, wherein each mechanism includes first and second spaced-apart members, wherein the legs and mounting portions are positioned between the first and second members, and wherein actuation of the mechanism into a clamped position reduces the space between the first and second members to raise friction between the smooth planar surfaces of the legs and the smooth planar surfaces of deck.

12. (canceled)

13. The lawn mower of claim 9, wherein each of the first and second mechanisms includes a portion extending through the first and second arcuate slots; and wherein the portions extending through the arcuate slots move along the arcuate slots as the handle is pivoted about the pivot axis with respect to the deck.

14-20. (canceled)
